(19) United States
(12) Patent Application Publication
(10) Pub. No.: US 2006/0182498 A1
(43) Pub. Date: Aug. 17, 2006

(54) Chemical applicator system for remediation of contaminated soil

(76) Inventor: Joe Hughes, Hobbs, NM (US)

Correspondence Address: PEACOCK MYERS, P.C., 201 THIRD STREET, N.W., SUITE 1340, ALBUQUERQUE, NM, 87102, US

(21) Appl. No.: 11/398,370

(22) Filed: Apr. 4, 2006

Related U.S. Application Data
(63) Continuation-in-part of application No. 10/793,192, filed on Mar. 3, 2004, now Pat. No. 7,021,862.
(60) Provisional application No. 60/452,127, filed on Mar. 4, 2003.

(30) Foreign Application Priority Data
Mar. 4, 2004 (MX) PA/A/2004/002106
Mar. 4, 2004 (CA) 2,460,604

(51) Int. Cl. B09C 1/08

(52) U.S. Cl. 405/128.5

(57) ABSTRACT

The present invention is a mobile, in situ applicator system and method for remediating contaminated soils at a site without the removal of those soils. The applicator system comprises a vehicle, preferably a chemical treatment vehicle used in the oil and gas industry, with a remediation fluid and fluid dispensing components for the application of the fluid to contaminated sites.

### CROSS-REFERENCE TO A RELATED APPLICATION

This application is a continuation-in-part application of U.S. patent application Ser. No. 10/793,192, titled “Applicator System for Remediation of Contaminated Soil”, filed Mar. 3, 2004, which claims priority to U.S. Provisional Patent Application Ser. No. 60/452,127, titled “Applicator System for Remediation of Contaminated Soil”, filed on Mar. 4, 2003, and the specifications and claims of those applications are incorporated herein by reference.

### BACKGROUND OF THE INVENTION

1. Field of the Invention (Technical Field)

The present invention relates to a mobile, in situ applicator system designed to remediate soils at a contaminated site without the removal of those soils and a method for the remediation of the soil. The applicator system comprises a combination of a vehicle, preferably a chemical treatment vehicle used in the oil and gas industry, and fluid dispensing components comprising a tank, hoses, and pump for the application to contaminated sites.

2. Description of Related Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

The application of bioadditives to contaminated soils for remediation purposes is known. Also known is the use of vehicles to deliver and dispense chemical fluids to sites wherein facilities and equipment related to the oil and gas industries are located. Such sites include, but are not limited to, oil well sites, gas well sites, oil processing facility sites, and gas processing facility sites. There is a need, however, for an efficient and economic means to deliver and apply bioadditives to oil and gas well sites that have become contaminated.

### BRIEF SUMMARY OF THE INVENTION

The present invention provides a mobile, in situ applicator system for the remediation of contaminated sites comprising a combination of a vehicle and applicator components for the application of fluids to contaminated sites. The vehicle may comprise a chemical treater truck typically utilized in an oil and gas industry.

Thus, an embodiment of the present invention comprises a mobile, in situ applicator system for the remediation of contaminated sites, the system comprising a chemical treater vehicle, a microbial and enzymatic enhancing remediation fluid disposed in a container in or on the vehicle, and applicator components for applying said remediation fluid to soil. The applicator components preferably comprise a hose connected to the container and a pump connected to the hose. The pump may comprise a high-pressure pump and may comprise a mechanical pump. The pump may be powered by the vehicle's power. The remediation fluid may comprise a surfactant. The remediation fluid may comprise a bioadditive such as, but not limited to, nitrogen, phosphorus, ammonium nitrate, sulfur, and a combination thereof.

Another embodiment provides a method for applying a remediation fluid to a contaminated site comprising providing a chemical treater vehicle, disposing at least one container on the vehicle, disposing a remediation fluid within the container to enhance microbial and enzymatic activities in soil, delivering the vehicle to at least one site containing soil contaminated with hydrocarbons, said site selected from the group consisting of, but not limited to, an oil well site, a gas well site, an oil processing facility site, a gas processing facility site, and a combination thereof, the delivery of the vehicle made in accordance with regularly scheduled maintenance of facility equipment at the site, and applying the remediation fluid to the ground at the contaminated site by taking the remediation fluid from the container to the ground without removing the fluid or soil. The method further comprises delivering the vehicle to the contaminated site in need of remediation. The remediation fluid may be applied at high pressure to aerate the soil and improve remediating microbial and enzymatic activities. A surfactant may be added to the container.

A primary object of the present invention is to remediate contaminated soil utilizing a remediation fluid application system that is mobile without the need to remove soil from the contaminated site.

A primary advantage of the present invention is that it is economical and efficient because existing chemical treating vehicles can be used as the means to make the apparatus mobile.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side view of a preferred vehicle utilized in accordance with the present invention equipped with a tank; and

FIG. 2 is a perspective view of the preferred applicator components disposable on the vehicle.

### DETAILED DESCRIPTION OF THE INVENTION

The present invention provides a mobile, in situ applicator system designed to remediate soils at a site without the removal of those soils. The invention further comprises a method for remediating the soils. Thus, the present invention provides a chemical treater or treatment vehicle (e.g., truck) of the type typically used in the oil and gas industries for the scheduled maintenance of facilities and equipment located at sites utilizing those facilities and equipment. As used herein, a chemical treatment vehicle is a vehicle used to deliver and dispense chemical fluids to such sites for the treatment of the facilities and equipment. Such sites include, but are not limited to, oil well sites, gas well sites, oil processing facility sites, and gas processing facility sites, and pipelines. As used herein, the terms “a”, “an”, and “the” mean one or more.

The chemical treater vehicle, as described herein, is utilized to treat contaminated soils typically found at such sites and typically contaminated with hydrocarbons. The vehicle is preferably equipped with at least one tank (i.e., container) within which is disposed a remediation fluid to enhance microbial and enzymatic activities in soil. The vehicle is delivered to a contaminated site (in accordance with a pre-existing, regularly scheduled maintenance of the facility equipment located at the site), and the remediation fluid is applied to the ground at the contaminated site. Therefore, the present invention takes advantage of the regularly scheduled use of chemical treater vehicles for treating equipment, and equips such vehicles with remediation fluid to, contemporaneous with the treatment of the facility equipment, treat the surrounding contaminated soil.

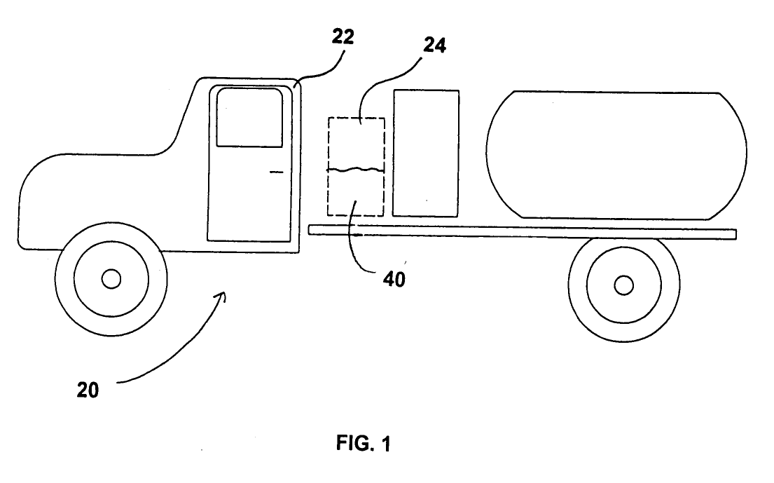

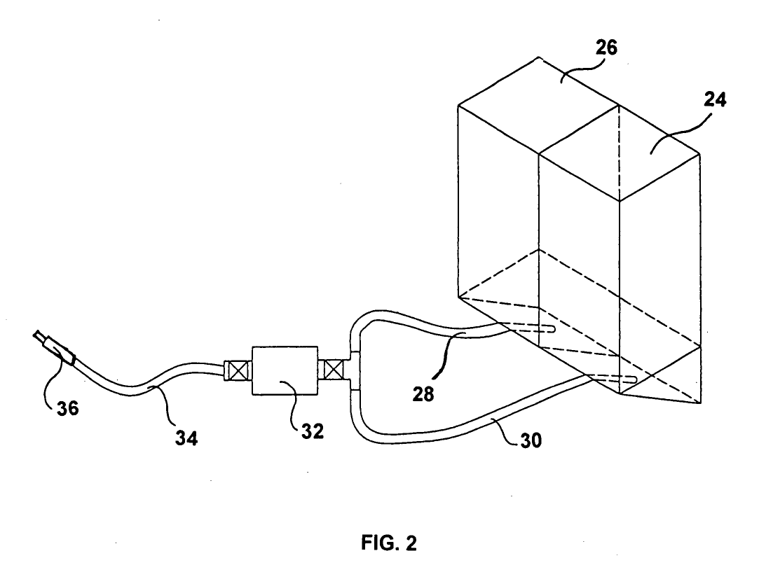

Turning now to the figures, FIGS. 1 and 2 show an embodiment wherein tank 24 is disposed on vehicle 20, preferably mounted on the frame of vehicle 20, just aft of vehicle cab 22. FIG. 2 shows the applicator components comprising tank 24 and tank 26 with tank hoses 28, 30 attached to pump 32. Discharge hose 34, with nozzle 36, is attached to pump 32. Vehicle 20 is preferably a “chemical treatment” truck used in an oil and gas industry, although any type vehicle may be utilized. Pump 32 is preferably mechanically driven and is preferably a high pressure pump. The components are for the application of remediation fluid 40 containing bioadditives in an aqueous solution to contaminated sites.

As noted above, the applicator system in this embodiment is used on contamination found at oil and gas wells, facilities and installations. These sites include, but are not limited to wellheads, piping, flow lines, pumping units, compressors, treating vessels, tanks, sumps and general areas on and near the location of producing and abandoned oil wells, injection wells, disposal wells, and gas wells on public and private lands.

Tanks 24, 26 preferably comprise steel or a structural material that is coated to prevent corrosion from the chemical cargo. Mechanical pump 32 is preferably disposed under tanks 24, 26. The discharge unit may have more than one hose, preferably two tank hoses 28, 30, one disposed on each side of the vehicle, and two discharge hoses (only one discharge hose, 34, is shown), one disposed on each side of the vehicle.

The applicator system uses suction from tanks 24, 26, through pump 32 and out of discharge hose 34. Hoses, 28, 30, and 34 are preferably made of a flexible material that is not damaged by the bioadditives. Nozzle 36 is preferably made of corrosion-resistant metal or similar materials.

In the preferred embodiment, the applicator system is placed close cab 22 of vehicle 20—in chemical treater trucks tanks 24, 26 are disposed in front of the other tanks typically disposed on such trucks. The applicator system is thus preferably a dedicated applicator system. Mechanical pump 32 preferably runs on power generated from vehicle 20. Pump 32 is preferably a high-pressure pump as delivery of remediation fluid 40 at high pressure helps deliver the remediation fluid and aerate the soil to improve the remediating microbial and enzymatic activities.

Remediation fluid 40 comprises bioadditives preferably comprising nitrogen, phosphorus, ammonium nitrate, sulfur, or any material designed to enhance remediation. These chemicals are preferably carried in Department of Transportation (DOT) approved compartments. The compartments most preferably have a capacity of approximately 100 gallons but can be of any size, e.g. 50-200 gallons, or even 10-7,000 gallons. As noted above, the chemicals enhance the activity of microbes and enzymes located in the soil so that the microbes and enzymes are able to digest, or otherwise act upon, the contaminants in the soil. As such, the chemicals are such as to not interfere, but rather enhance, the activity of microbes.

The mobile applicator system is preferably used in conjunction with a non-ionic biodegradable surfactant. This material is compatible with bioadditives and fresh water used to treat the contaminated soil. The addition of surfactants to the remediation solution appears to aid in aeration and delivery of the remediation fluid.

The applicator system is preferably mounted on the frame of vehicle 20. When vehicle 20 is a chemical treater truck, the preferred mounted applicator system is economical because the chemical treater truck is on a well-head cleaning schedule that brings vehicle 20 to areas where soil contamination is often found. Thus, monitoring and site application during scheduled well-head maintenance is facilitated.

An alternative embodiment is a stationary applicator system with two remediation fluid tanks 24, 26, a water tank (not shown), hoses 28, 30, 34, nozzle 36 and mechanical pump 32 at a functioning site or other appropriate site with contaminated soil.

In an alternative embodiment, the applicator system is used for other types of contaminated soils and the additives are synergistic with the soil contaminants.

Another alternative embodiment is the use of the applicator system at sites where contaminated soils have been removed, for example a land farm or hazardous waste facility.

### EXAMPLE

A chemical treater truck alternately equipped with 50 to 200 gallon tanks carrying various ratios of nitrates, sulfur, and ammonium nitrate in aqueous solution was used during monitoring and site application following regularly scheduled well-head maintenance. The remediation fluid was applied in stages once a month or every other month for a period of 7 to 9 months.

Soil condition was monitored. Visually, the soil showed demonstrable improvement to near original appearance. Chemical analysis of hydrocarbons showed an approximately 95% reduction in contaminating hydrocarbons.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, and of the corresponding application(s), are hereby incorporated by reference.

What is claimed is:

1. A mobile, in situ applicator system for the remediation of contaminated sites, said system comprising:
a chemical treater vehicle;
a microbial and enzymatic enhancing remediation fluid disposed in a container in or on said vehicle; and
applicator components for applying said remediation fluid to soil.

2. The system of claim 1 wherein said applicator components comprise:
a hose connected to said container; and
a pump connected to said hose

3. The system of claim 2 wherein said pump comprises a high-pressure pump.

4. The system of claim 2 wherein said pump comprises a mechanical pump.

5. The system of claim 2 wherein said pump is powered by said vehicle's power.

6. The system of claim 1 wherein said remediation fluid comprises a surfactant.

7. The method of claim 1, said remediation comprising a bioadditive selected from the group consisting of nitrogen, phosphorus, ammonium nitrate, sulfur, and a combination thereof.

8. A method for applying a remediation fluid to a contaminated site, the method comprising the steps of:
providing a chemical treater vehicle;
disposing a container on the vehicle;
disposing a remediation fluid within the container, the remediation fluid for enhancing microbial and enzymatic activities in soil;
delivering the vehicle to at least one site containing soil contaminated with hydrocarbons, said site selected from the group consisting of an oil well site, a gas well site, an oil processing facility site, a gas processing facility site, and a combination thereof, said delivery of the vehicle made in accordance with regularly scheduled maintenance of facility equipment at the site;
applying the remediation fluid to the ground at the contaminated site by taking the remediation fluid from the at least one tank to the ground without removing the fluid or soil; and
enhancing microbial and enzymatic activities in the soil to act upon contaminants in the soil.

9. The method of claim 8 further comprising the step of delivering the vehicle to the contaminated site in need of remediation.

10. The method of claim 8 further comprising applying the remediation fluid at high pressure to aerate the soil and improve remediating microbial and enzymatic activities.

11. The method of claim 8 further comprising the step of adding a surfactant to the container.

12. The method of claim 8, said remediation comprising a bioadditive selected from the group consisting of nitrogen, phosphorus, ammonium nitrate, sulfur, and a combination thereof.
